(19) United States
(12) Patent Application Publication
(10) Pub. No.: US 2021/0340325 A1
(43) Pub. Date: Nov. 4, 2021

(54) POLYIMIDE PRECURSOR, POLYIMIDE PRODUCED FROM SAME, AND FLEXIBLE DEVICE

(71) Applicant: NIPPON STEEL Chemical & Material Co., Ltd., Tokyo (JP)

(72) Inventors: Hongyuan WANG, Tokyo (JP); Katsufumi HIRAISHI, Tokyo (JP); Nobuyuki HAYASHI, Tokyo (JP); Toshihiro MORIMOTO, Tokyo (JP)

(73) Assignee: NIPPON STEEL Chemical & Material Co., Ltd., Tokyo (JP)

(21) Appl. No.: 17/280,918

(22) PCT Filed: Sep. 30, 2019
(86) PCT No.: PCT/JP2019/038442

§ 371 Date: Mar. 29, 2021

(30) Foreign Application Priority Data
Sep. 29, 2018 (JP) 2018-186221

(51) Int. Cl. C08G 73/10; C08L 79/08

(52) U.S. Cl. CPC C08G 73/1007; C08L 2203/16; C08L 79/08; C08G 73/1071

(57) ABSTRACT

A polyimide precursor which is characterized by: containing, as a structural unit derived from a diamine, a structural unit derived from 2,2-bis(trifluoromethyl)benzidine in an amount of 60% by mole or more with respect to all structural units derived from a diamine; and containing, as structural units derived from a tetracarboxylic dianhydride, structural units derived from one or more kinds selected from 4,4′-(2,2′-hexafluoroisopropylidene)diphthalic dianhydride and 4,4′-oxydiphthalic dianhydride in a total amount of 20% by mole or more with respect to all structural units derived from a tetracarboxylic acid dianhydride, in which a yellowness index (converted for a film thickness of 10 μm) for a polyimide obtained by imidization is 10 or less, and a tear propagation resistance is 1.0 mN/μm or more.

### TECHNICAL FIELD

The present invention relates to a polyimide, which has a high transparency, a low coefficient of thermal expansion, a low retardation, and tear resistance, and is useful as a supporting base material for forming a display device; a precursor of the polyimide; and a flexible device.

### BACKGROUND ART

Display devices such as organic EL devices and touch panels are used as constituent members of various displays including large displays such as televisions and small displays such as mobile phones, personal computers, and smartphones. For example, an organic EL device is generally produced as follows: a thin-film transistor (TFT) is formed on a glass substrate which is a support substrate; an electrode, a light emitting layer, and an electrode are further sequentially formed on the thin-film transistor; and these are sealed in an air-tight manner with a glass substrate, a multilayer thin film, or the like. Furthermore, a touch panel has a configuration in which a first glass substrate on which a first electrode is formed, and a second glass substrate on which a second electrode is formed are joined via an insulating layer (dielectric layer).

These constituent members are a laminate in which various functional layers are formed on a glass substrate. By replacing this glass substrate with a resin substrate, it is possible to make the constituent members thinner, lighter, and more flexible than conventional constituent members in which a glass substrate is used. It is expected that a flexible device such as a flexible display will be obtained by utilizing these constituent members. Meanwhile, various studies have been conducted on resins because resins are inferior to glass in (i) dimensional stability, (ii) transparency, (iii) heat resistance, and the like. As a resin substrate, polyimides having relatively excellent characteristics of (i) to (iii) have been particularly actively studied.

The characteristics of a polyimide depend on a composition of monomers (mainly diamines and tetracarboxylic dianhydrides) constituting it. Accordingly, it is important to select excellent monomers in order to manufacture a resin substrate having the above-mentioned characteristics.

As one of excellent monomers, there is 2,2-bis(trifluoromethyl)benzidine (TFMB). TFMB is a fluorine-containing aromatic diamine. It is expected that introducing TFMB as a monomer for a polyimide will improve the above-mentioned characteristics of a polyimide substrate. Furthermore, as a fluorine-containing aromatic diamine, TFMB has an industrially extremely important advantage, which is a relatively low production cost.

For these reasons, many studies have been conducted on resin substrates formed using TFMB (Patent Literature 1 to Patent Literature 5).

However, the current situation is that a polyimide substrate having characteristics sufficient to replace a glass substrate has not appeared even with a polyimide formed using TFMB.

In particular, (iv) low birefringence (retardation) of a resin is important in addition to the above-mentioned characteristics of (i) to (iii) in order to apply a resin substrate in flexible display usage applications. (iv) is a physical property required to obtain a clear image. There are two kinds of retardation: retardation in an in-plane direction of a substrate, and retardation (Rth) in a film thickness direction of a substrate. Rth is a particularly important characteristic because when a birefringence is large, double images appear, or colors become blurred. However, none of Patent Literature 1 to Patent Literature 4 discloses whether Rth shows a sufficiently low value in a polyimide formed using TFMB.

In addition, as another important characteristic required for a polyimide substrate, there is (v) high tear propagation resistance. Manufacturing of flexible devices includes a step of forming a polyimide layer on a supporting base material such as glass, further forming a functional layer on the supporting base material, and peeling off the supporting base material. However, when stripping a film from an inorganic substrate, the film is required to have a certain high level of mechanical properties such as mechanical strength and elongation, and particularly when a tear propagation resistance is low, there is a problem of tearing of the film when being peeled off. Accordingly, a film used as a supporting base material is required to have a high tear propagation resistance. Therefore, from Patent Literature 5, the inventors of the present invention have found a polyimide film which is formed using TFMB and which can satisfy having dimensional stability, heat resistance, transparency, and a high tear propagation resistance at the same time.

Based on the above description, (iv) low Rth and (v) high tear propagation resistance are particularly required in addition to (i) dimensional stability, (ii) transparency, and (iii) heat resistance in order to apply a polyimide substrate formed using TFMB as a substrate for a flexible device. However, it has been difficult to satisfy having the characteristics of (i) to (v) at the same time by conventional techniques.

### CITATION LIST

### Patent Literature

### Patent Literature 1

Japanese Patent Laid-Open No. 2012-040836

### Patent Literature 2

PCT International Publication No. 2014/098235

### Patent Literature 3

PCT International Publication No. 2015/125895

### Patent Literature 4

PCT International Publication No. 2016/158825

### Patent Literature 5

Japanese Patent Laid-Open No. 2015-187987

### SUMMARY OF INVENTION

### Technical Problem

An objective of the present invention is to provide a polyimide having a low Rth and a high tear propagation resistance in addition to excellent dimensional stability, transparency, and heat resistance; and a precursor of the polyimide.

### Solution to Problem

As a result of diligent studies, the inventors of the present invention have found that a specific polyimide precursor and a polyimide produced from the specific polyimide precursor can satisfy having the above characteristics, and therefore have completed the present invention.

That is, a polyimide precursor of the present invention is a polyimide precursor including: a structural unit derived from a diamine; and a structural unit derived from a tetracarboxylic dianhydride.

In the polyimide precursor of the present invention, as the structural unit derived from a diamine, a structural unit i) derived from 2,2-bis(trifluoromethyl)benzidine is contained in an amount of 60% by mole or more with respect to all structural units derived from a diamine, and as the structural unit derived from a tetracarboxylic dianhydride, structural units ii) derived from one or more kinds selected from 4,4′-(2,2′-hexafluoroisopropylidene)diphthalic dianhydride and 4,4′-oxydiphthalic dianhydride are contained in a total amount of 20% by mole or more with respect to all structural units derived from a tetracarboxylic dianhydride. In addition, in the polyimide precursor of the present invention, a yellowness index (converted for a film thickness of 10 μm) for a polyimide obtained by imidization is 10 or less, and a tear propagation resistance is 1.0 mN/μm or more.

In the polyimide precursor of the present invention, a weight-average molecular weight may be within a range of 80,000 to 800,000.

In the polyimide precursor of the present invention, an elongation of a polyimide film obtained by imidization at a film thickness of 5 to 20 μm may be 10% or more.

In the polyimide precursor of the present invention, a retardation (converted for a film thickness of 10 μm) in a thickness direction of a polyimide film obtained by imidization may be 65 nm or less.

A polyimide of the present invention is a polyimide including: a structural unit derived from a diamine; and a structural unit derived from a tetracarboxylic dianhydride. In the polyimide of the present invention, as the structural unit derived from a diamine, a structural unit i) derived from 2,2-bis(trifluoromethyl)benzidine is contained in an amount of 60% by mole or more with respect to all structural units derived from a diamine, and as the structural unit derived from a tetracarboxylic dianhydride, structural units ii) derived from one or more kinds selected from 4,4′-(2,2′-hexafluoroisopropylidene)diphthalic dianhydride and 4,4′-oxydiphthalic dianhydride are contained in a total amount of 20% by mole or more with respect to all structural units derived from a tetracarboxylic dianhydride. In addition, in the polyimide of the present invention, a yellowness index (converted for a film thickness of 10 μm) is 10 or less, and a tear propagation resistance is 1.0 mN/μm or more.

In the polyimide of the present invention, an elongation in a state of a film having 5 to 20 μm may be 10% or more.

In the polyimide of the present invention, a retardation (converted for a film thickness of 10 μm) in a thickness direction in a state of a film may be 65 nm or less.

In the polyimide of the present invention, as the structural unit derived from a diamine, the structural unit i) derived from 2,2-bis(trifluoromethyl)benzidine may be contained in an amount of 80% by mole or more with respect to the all structural units derived from a diamine.

In the polyimide of the present invention, as the structural unit derived from a tetracarboxylic dianhydride, the structural units ii) derived from one or more kinds selected from 4,4′-(2,2′-hexafluoroisopropylidene)diphthalic dianhydride and 4,4′-oxydiphthalic dianhydride may be contained in a total amount of 25% by mole or more with respect to the all structural units derived from a tetracarboxylic dianhydride.

A flexible device of the present invention is a flexible device in which a functional layer is formed on a polyimide layer containing any of the above-described polyimides.

### Advantageous Effects of Invention

A polyimide precursor of the present invention or a polyimide obtained from the polyimide precursor has an excellent Rth and tear propagation resistance in addition to excellent dimensional stability, transparency, and heat resistance. In particular, low Rth is excellent when 4,4′-(2,2′-hexafluoroisopropylidene)diphthalic dianhydride is used. Furthermore, extension is excellent even in a case of a thin film having a thickness of about 5 to 20 μm when 4,4′-oxydiphthalic dianhydride is used. Furthermore, when TFMB is used as a raw material monomer, manufacturing costs can be reduced and productivity is excellent. Accordingly, the polyimide precursor of the present invention and the polyimide obtained from the polyimide precursor are suitable for, for example, a polyimide film for a resin substrate of a display device, a touch panel, and the like, and they can be suitably applied for a flexible device in which a functional layer is formed on a surface of a polyimide film on the surface, where the functional layer is a display element, a light emitting element, a circuit, a conductive film such as ITO, a metal mesh, a hard coat film, or a gas barrier film that prevents permeation of moisture, oxygen, and the like.

### DESCRIPTION OF EMBODIMENTS

A polyimide precursor of the present invention is a polyimide precursor including a structural unit derived from a diamine, and a structural unit derived from a tetracarboxylic dianhydride (hereinafter simply referred to as an acid dianhydride), in which, as the structural unit derived from a diamine, a structural unit i) derived from 2,2-bis(trifluoromethyl)benzidine (TFMB) is contained in an amount of 60% by mole or more with respect to all structural units derived from a diamine, and as the structural unit derived from a tetracarboxylic dianhydride, structural units ii) derived from one or more kinds selected from 4,4′-(2,2′-hexafluoroisopropylidene)diphthalic dianhydride (6FDA) and 4,4′-oxydiphthalic dianhydride (ODPA) are contained in a total amount of 20% by mole or more with respect to all structural units derived from a tetracarboxylic dianhydride. These structural units are retained as they are even in a polyimide obtained by imidizing the polyimide precursor of the present invention.

In addition, in the polyimide precursor of the present invention, a yellowness index (converted for a film thickness of 10 μm) for a polyimide obtained by imidization is 10 or less, and a tear propagation resistance is 1.0 mN/μm or more.

Structural units of the polyimide precursor and the polyimide and ratios of the structural units are determined by the type and usage ratios of the diamines and tetracarboxylic dianhydrides, and therefore the structural units will be described in descriptions for diamines and acid dianhydrides. A usage ratio of diamines and acid dianhydrides is an abundance ratio between each of structural units derived therefrom.

Regarding TFMB mentioned above, it is preferable that 80% by mole or more thereof be contained, and it is more preferable that 90% by mole or more thereof be contained, with respect to a total amount of diamines, from the viewpoint of heat resistance, a low coefficient of thermal expansion (low CTE), and transparency of a polyimide manufactured using TFMB as a monomer (hereinafter, also simply referred to as a “polyimide”).

In addition to TFMB, other diamines can be used for the purpose of imparting desired characteristics to a polyimide. In a case of using other diamines, they are preferably used within a range of less than 40% by mole, preferably less than 20% by mole, and more preferably less than 10% by mole, with respect to a total amount of diamines.

As the other diamines, it is possible to use a diamine having one or more aromatic rings from the viewpoint of heat resistance and a low CTE of a polyimide. Examples of such diamines include 2,2′-dimethyl-4,4′-diaminobiphenyl (also known as 2,2′-dimethyl-benzidine), 3,3′-dimethyl-4,4′-diaminobiphenyl, 4,4′-diaminodiphenyl ether, 3,4′-diaminodiphenyl ether, 4,6-dimethyl-m-phenylenediamine, 2,5-dimethyl-p-phenylenediamine, 2,4-diaminomesitylene, 4,4′-methylenedi-o-toluidine, 4,4′-methylenedi-2,6-xylidine, 4,4′-methylene-2,6-diethylaniline, 2,4-toluenediamine, m-phenylenediamine, p-phenylenediamine, 4,4′-diaminodiphenylpropane, 3,3′-diaminodiphenylpropane, 4,4′-diaminodiphenylethane, 3,3′-diaminodiphenylethane, 4,4′-diaminodiphenylmethane, 3,3′-diaminodiphenylmethane, 2,2-bis[4-(4-aminophenoxy)phenyl]propane, 4,4′-diaminodiphenyl sulfide, 3,3′-diaminodiphenyl sulfide, 4,4′-diaminodiphenyl sulfone, 3,3′-diaminodiphenyl sulfone, 4,4′-diaminodiphenyl ether, 3,3′-diaminodiphenyl ether, 1,3-bis(3-aminophenoxy)benzene, 1,3-bis(4-aminophenoxy)benzene, 1,4-bis(4-aminophenoxy)benzene, benzidine, 3,3′-diaminobiphenyl, 3,3′-dimethyl-4,4′-diaminobiphenyl, 3,3′-dimethoxybenzidine, 4,4′-diamino-p-terphenyl, 3,3′-diamino-p-terphenyl, bis(p-β-amino-t-butylphenyl)ether, bis(p-β-methyl-6-aminopentyl)benzene, p-bis(2-methyl-4-aminopentyl)benzene, p-bis(1,1-dimethyl-5-aminopentyl)benzene, 1,5-diaminonaphthalene, 2,6-diaminonaphthalene, 2,4-bis(β-amino-t-butyl)toluene, 2,4-diaminotoluene, m-xylene-2,5-diamine, p-xylene-2,5-diamine, m-xylylenediamine, p-xylylenediamine, 2,6-diaminopyridine, 2,5-diaminopyridine, 2,5-diamino-1,3,4-oxadiazole, piperazine, 5-amino-2-(4-aminophenyl)benzimidazole, and the like.

Among them, 4,4′-diaminodiphenyl ether, 4,6-dimethyl-m-phenylenediamine, 2,5-dimethyl-p-phenylenediamine, 2,4-diaminomesitylene, 2,4-toluenediamine, m-phenylenediamine, 2,2′-dimethyl-4,4′-diaminobiphenyl, 5-amino-2-(4-aminophenyl)benzimidazole, or p-phenylenediamine is more preferable from the viewpoint that then, a polyimide-generating reaction is fast, and a polyimide is highly transparent. 2,2′-Dimethyl-4,4′-diaminobiphenyl, 5-amino-2-(4-aminophenyl)benzimidazole, or 4,4′-diaminodiphenyl ether is even more preferable.

Furthermore, as the other diamines, a diamine having a siloxane skeleton may be applied from the viewpoint of flexibility of a polyimide such as low elasticity properties and a low residual stress. Examples of diamines having a siloxane skeleton include diaminopropyltetramethyldisiloxane, and methylphenyl silicone in which amino acids at both terminals are modified.

Furthermore, as the other diamines, a diamine having an alicyclic structure may be applied from the viewpoint of transparency and a low CTE of a polyimide. Examples of diamines having an alicyclic structure include 1,4-cyclohexanedicarboxylic acid.

One or more monomers selected from 6FDA and ODPA described above are contained in an amount of 20% by mole or more and preferably 25% by mole or more with respect to a total amount of tetracarboxylic dianhydrides from the viewpoint of heat resistance and transparency of a polyimide manufactured using 6FDA and ODPA as monomers. In the case of 6FDA, a lower limit is preferably 60% by mole, is more preferably 80% by mole, and is even more preferably 90% by mole, from the viewpoint of a low Rth. In the case of ODPA, a lower limit is preferably 25% by mole, is more preferably 30% by mole, and is even more preferably 35% by mole, from the viewpoint of a low Rth. Furthermore, in the case of ODPA, an upper limit is preferably 60% by mole, is more preferably 50%, and is even more preferably 40%, from the viewpoint of a low CTE.

In addition to 6FDA or ODPA, it is possible to use other tetracarboxylic dianhydrides for the purpose of imparting desired characteristics to a polyimide. In a case of using the other tetracarboxylic dianhydrides, they are preferably used within a range of less than 40% by mole, preferably less than 20% by mole, and more preferably less than 10% by mole, with respect to a total amount of tetracarboxylic dianhydrides.

Examples of the other tetracarboxylic dianhydrides include naphthalene-2,3,6,7-tetracarboxylic dianhydride, naphthalene-1,2,5,6-tetracarboxylic dianhydride, naphthalene-1,2,6,7-tetracarboxylic dianhydride, pyromellitic acid dianhydride, 3,3′,4,4′-biphenyltetracarboxylic dianhydride, 3,3′,4,4′-benzophenonetetracarboxylic dianhydride, 2,2′,3,3′-benzophenonetetracarboxylic dianhydride, 2,3,3′,4′-benzophenonetetracarboxylic dianhydride, naphthalene-1,2,4,5-tetracarboxylic dianhydride, naphthalene-1,4,5,8-tetracarboxylic dianhydride, naphthalene-1,2,6,7-tetracarboxylic dianhydride, 4,8-dimethyl-1,2,3,5,6,7-hexahydronaphthalene-1,2,5,6-tetracarboxylic dianhydride, 4,8-dimethyl-1,2,3,5,6,7-hexahydronaphthalene-2,3,6,7-tetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, 1,4,5,8-tetrachloronaphthalene-2,3,6,7-tetracarboxylic dianhydride, 2,2′,3,3′-biphenyltetracarboxylic dianhydride, 2,3,3′,4′-biphenyltetracarboxylic dianhydride, 3,3″,4,4″-p-terphenyltetracarboxylic dianhydride, 2,2″,3,3″-p-terphenyltetracarboxylic dianhydride, 2,3,3″,4″-p-terphenyltetracarboxylic dianhydride, 2,2-bis(2,3-dicarboxyphenyl)propane dianhydride, 2,2-bis(3,4-dicarboxyphenyl)propane dianhydride, bis(2,3-dicarboxyphenyl)ether dianhydride, bis(2,3-dicarboxyphenyl)methane dianhydride, bis(3,4-dicarboxyphenyl)methane dianhydride, bis(2,3-dicarboxyphenyl)sulfone dianhydride, bis(3,4-dicarboxyphenyl)sulfone dianhydride, 1,1-bis(2,3-dicarboxyphenyl)ethane dianhydride, 1,1-bis(3,4-dicarboxyphenyl)ethane dianhydride, perylene-2,3,8,9-tetracarboxylic dianhydride, perylene-3,4,9,10-tetracarboxylic dianhydride, perylene-4,5,10,11-tetracarboxylic dianhydride, perylene-5,6,11,12-tetracarboxylic dianhydride, phenanthrene-1,2,7,8-tetracarboxylic dianhydride, phenanthrene-1,2,6,7-tetracarboxylic dianhydride, phenanthrene-1,2,9,10-tetracarboxylic dianhydride, cyclopentane-1,2,3,4-tetracarboxylic dianhydride, pyrazine-2,3,5,6-tetracarboxylic dianhydride, pyrrolidine-2,3,4,5-tetracarboxylic dianhydride, thiophene-2,3,4,5-tetracarboxylic dianhydride, (trifluoromethyl)pyromellitic dianhydride, di(trifluoromethyl)pyromellitic dianhydride, di(heptafluoropropyl)pyromellitic dianhydride, pentafluoroethyl pyromellitic dianhydride, bis{3,5-di(trifluoromethyl)phenoxy}pyromellitic dianhydride, 2,2-bis(3,4-dicarboxyphenyl)hexafluoropropane dianhydride, 5,5′-bis(trifluoromethyl)-3,3′,4,4′-tetracarboxybiphenyl dianhydride, 2,2′,5,5′-tetrakis(trifluoromethyl)-3,3′,4,4′-tetracarboxybiphenyl dianhydride, 5,5′-bis(trifluoromethyl)-3,3′,4,4′-tetracarboxydiphenyl ether dianhydride, 5,5′-bis(trifluoromethyl)-3,3′,4,4′-tetracarboxybenzophenone dianhydride, bis{(trifluoromethyl)dicarboxyphenoxy}benzene dianhydride, bis{(trifluoromethyl)dicarboxyphenoxy}trifluoromethylbenzene dianhydride, bis(dicarboxyphenoxy)trifluoromethylbenzene dianhydride, bis(dicarboxyphenoxy)bis(trifluoromethyl)benzene dianhydride, bis(dicarboxyphenoxy)tetrakis(trifluoromethyl)benzene dianhydride, 2,2-bis{4-(3,4-dicarboxyphenoxy)phenyl}hexafluoropropane dianhydride, bis{(trifluoromethyl)dicarboxyphenoxy}biphenyl dianhydride, bis{(trifluoromethyl)dicarboxyphenoxy}bis(trifluoromethyl)biphenyl dianhydride, bis{(trifluoromethyl)dicarboxyphenoxy}diphenyl ether dianhydride, bis(dicarboxyphenoxy)bis(trifluoromethyl)biphenyl dianhydride, and the like. In addition, these may be used alone, or two or more kinds thereof may be used in combination.

As the other tetracarboxylic dianhydrides, pyromellitic dianhydride (PMDA) and 3,3′,4,4′-biphenyltetracarboxylic dianhydride (BPDA), which can impart strength, flexibility, and a property of having a low CTE to a polyimide, are preferable.

In addition, 1,2,3,4-cyclobutanetetracarboxylic dianhydride (CBDA) and 1,2,4,5-cyclohexanetetracarboxylic dianhydride (CHDA) are preferable, because they have excellent heat resistance and transparency and enable control such that a CTE is within an appropriate range.

The polyimide precursor of the present invention may be one kind of polyimide precursor, or may be a mixture of two or more kinds of polyimide precursor. In the latter case, a preferred content of each of raw material monomers is calculated as a content of a mixture thereof with respect to all structural units.

In the polyimide precursor of the present invention, a yellowness index (converted for a film thickness of 10 μm) for a polyimide obtained by imidization is 10 or less, and a tear propagation resistance is 1.0 mN/μm or more. For these excellent characteristics to be exhibited, a weight-average molecular weight (Mw) of the polyimide precursor is preferably 80,000 to 800,000. As a method of setting an Mw within this range, there is optimization of reaction conditions such as a formulation ratio of tetracarboxylic dianhydrides and diamines.

As techniques of optimizing the reaction conditions, there are (I) polymerization at a high substrate concentration in a reaction solvent, (II) formulation ratio of raw material monomers, and (III) reaction conditions (temperature, time) for a varnish.

In a case of performing (I) polymerization at a high substrate concentration, a concentration of solid contents in raw material monomers in a raw material solution is adjusted. In a case of optimizing a concentration of solid contents, a concentration of solid contents in a monomer group containing the diamine and the tetracarboxylic dianhydride in a varnish is preferably set to 10 wt % to 40 wt %. Accordingly, a tear propagation resistance is increased.

Generally, in an intermolecular reaction, increasing a concentration of a reactive substrate increases a collision probability of monomer molecules, and thereby a reaction rate is likely to increase.

However, when a concentration of a reaction substrate is too high, that is, when a concentration of a monomer in a solvent exceeds 40 wt %, a polyimide precursor made to have a high molecular weight does not sufficiently dissolve but precipitates, and this makes it extremely difficult to form a thin film. From the above viewpoint, a lower limit is more preferably 12 wt % and is even more preferably 17 wt %. Furthermore, an upper limit is more preferably 30 wt % and is even more preferably 25 wt %.

In a case where a monomer with low solubility or low reaction activity is selected, the following steps may be added: a step of devising the order of adding each monomer for proper polymerization; a step of adding each monomer into an organic solvent, and thereafter heating and stirring; and a step of adding each monomer into an organic solvent, and thereafter irradiating with ultrasonic waves.

Regarding optimization of (II) formulation ratio, it is sufficient for usage amounts of diamine and tetracarboxylic dianhydride, which are raw material monomers, to be adjusted as described above. Specifically, it is preferable to adjust a molar ratio of tetracarboxylic dianhydride/diamine within a range of 0.985 to 1.003 in order to obtain a varnish having an appropriate molecular weight. Furthermore, a range of 0.987 to 1.002 is more preferable. Accordingly, a tear propagation resistance is increased.

Generally, in the case of a polyimide obtained by addition polymerization from acid dianhydride and diamine, a molecular weight is likely to become highest as a molar ratio of tetracarboxylic dianhydride/diamine becomes closer to 1. On the other hand, as a molar ratio becomes farther from 1, a terminal functional group is biased toward either an acid anhydride structure or an amino group as a polymerization reaction proceed, which causes a terminal reaction to not proceed, and thereby an increase of a molecular weight is unlikely to proceed. As described above, a viscosity is extremely high when a molecular weight is excessively high, and there is a tendency of problems to occur, such as difficulty in forming a film and a decrease in elongation. On the other hand, when a molecular weight is excessively low, tear propagation resistance of a polyimide is likely to decrease. Furthermore, an effect of reducing Rth is unlikely to be obtained.

Moreover, reaction activities of each of monomers are different. Accordingly, a molar ratio of acid anhydride/diamine fluctuates greatly from a formulation ratio and becomes excessively large or small, and for example, even when a molar ratio of tetracarboxylic dianhydride/diamine is 1 at the time of incorporating them, a molecular weight may not become sufficiently high. In regard to the above description, in the polyimide precursor of the present invention, an Mw of the polyimide precursor can be set within a range of 80,000 to 800,000 by selecting an appropriate monomer and selecting a molar ratio of tetracarboxylic dianhydride/diamine suitable for each monomer. Furthermore, a tear propagation resistance of a polyimide obtained by imidization becomes 1.0 mN/μm or more.

In order to set a molar ratio of tetracarboxylic dianhydride/diamine within an appropriate range, the following steps may be added: a step of changing the order of adding each monomer into an organic solvent; a step of adding each monomer into an organic solvent, and thereafter heating and stirring; and a step of adding each monomer into an organic solvent, and thereafter irradiating with ultrasonic waves.

In a case of optimizing (III) reaction conditions, a monomer group containing the diamine and the tetracarboxylic dianhydride is preferably subjected to a step of heating at 35° C. to 50° C. for 1 to 10 hours in an organic solvent. Accordingly, a tear propagation resistance is increased. In general, in conditions for reacting a monomer group containing diamine and tetracarboxylic dianhydride in an organic solvent, there is a tendency of problems to occur, such as more difficulty in controlling a polymerization reaction accompanying an increase of a reaction temperature, and thereby occurrence of gelation. Therefore, although a reaction temperature may be raised in order to dissolve monomers to be used, a reaction is generally carried out at the lowest possible temperature.

In regard to the above description, in the polyimide precursor of the present invention, an Mw of the polyimide precursor can be set within a range of 80,000 to 800,000 even when a reaction temperature in an organic solvent is high. A specific reaction temperature is preferably 35° C. to 50° C., and a specific reaction time is preferably 1 to 10 hours. Even under such reaction conditions, in the obtained polyimide precursor of the present invention, an Mw is within a range of 80,000 to 800,000, and a tear propagation resistance of a polyimide obtained by imidization is 1.0 mN/μm or more.

Furthermore, since an appropriate monomer is selected as described above, a polyimide, in which a yellowness index (converted for a film thickness of 10 μm) is 10 or less and a coefficient of thermal expansion is 100 ppm/K or less, is obtained particularly for a case in which 6FDA is used. When a heating temperature is lower than 35° C., a high-molecular weight resin cannot be obtained, and therefore the effect of improving a tear propagation resistance and the effect of reducing Rth cannot be obtained. Meanwhile, when a temperature is higher than 50° C., a reverse reaction of polymerization occurs, and therefore a high-molecular weight resin cannot be obtained. When a heating time is shorter than 1 hour, a high-molecular weight resin cannot be obtained, and therefore the effect of improving a tear propagation resistance and the effect of reducing Rth cannot be obtained. Meanwhile, when a heating time is longer than 10 hours, a reverse reaction of polymerization occurs, and therefore a high-molecular weight resin cannot be obtained.

Particularly from the viewpoint of suppressing an Rth to a low level, a heating temperature is preferably 40° C. to 50° C., and a heating time is preferably 1 to 6 hours and is more preferably 1 to 4 hours.

In order to improve a degree of polymerization, it is preferable to perform a step of heating at 35° C. to 50° C. for 1 to 10 hours, and thereafter to perform a step of further stirring at 5° C. to 35° C. for 5 hours or longer. A stirring temperature is more preferably 10° C. to 35° C., and is even more preferably 15° C. to 30° C. Furthermore, a stirring time is more preferably 10 hours or longer. By carrying out the stirring step over a sufficient period of time as described above, a degree of polymerization of the polyimide precursor is increased, and thereby the polyimide precursor having an Mw of 80,000 to 800,000 can be easily obtained.

The above-described techniques of (I) to (III) may be applied individually, but it is more preferable to perform the techniques (I) to (III) in combination. By optimizing these techniques, in the obtained polyimide precursor of the present invention, an Mw is within a range of 80,000 to 800,000, and a tear propagation resistance of a polyimide obtained by imidization is 1.0 mN/μm or more.

Particularly in the case in which 6FDA is used, an Rth of the polyimide is suppressed to a low level by the above-described step, and an Rth (converted for a film thickness of 10 μm) becomes 65 nm or less.

Furthermore, in a case in which ODPA is used, extension is excellent even when a thin film polyimide film having a thickness of about 5 to 20 μm. Specifically, an amount of extension (also referred to as “elongation”) is 20% or more in a polyimide film having a thickness of about 10 μm, and extension can be maintained at a value of 10% or more even in a polyimide film having a thickness of about 6 μm. Furthermore, by optimizing a composition, an amount of extension of a polyimide film having a thickness of about 6 μm can be maintained at 70% or more of extension of a polyimide film having a thickness of about 10 μm.

In recent years, since electronic devices have become smaller and lighter, there is a demand for flexible devices thinner than conventional flexible devices. In such usage applications, it is possible to particularly suitably use the polyimide precursor of the present invention in which ODPA is used.

The organic solvent is preferably a polar solvent, and examples thereof include N,N-dimethylacetamide, N-methyl-2-pyrrolidone, dimethylformamide, 2-butanone, diglyme, and xylene. In addition, xylene, hexane, and the like can be added to increase solubility. N,N-dimethylacetamide or N-methyl-2-pyrrolidone is more preferable.

Furthermore, the above-described heating may be carried out in the atmosphere, but it is preferably carried out in a nitrogen stream. Furthermore, a molecular terminal of the polyimide precursor may be sealed with monoamine or monocarboxylic dianhydride.

The polyimide of the present invention is obtained by imidizing the polyimide precursor of the present invention. The imidization can be carried out by a thermal imidization method, a chemical imidization method, or the like.

The thermal imidization is performed by applying a polyimide precursor onto an arbitrary supporting base material such as glass, metal, or resin using an applicator, pre-drying at a temperature of 150° C. or lower for 2 to 60 minutes, removing a solvent, thereafter, raising a temperature stepwise generally from room temperature for imidization, and performing a heat treatment at 450° C. for about 10 minutes to 20 hours. It is possible to change a temperature in the heat treatment according to required mechanical properties. A maximum temperature in the heat treatment for imidization is preferably 350° C. to 450° C. and is more preferably 360° C. to 400° C. from the viewpoint of heat resistance and mechanical strength of a polyimide. In addition, in the thermal imidization, when a combination of the type of acid dianhydride and diamine and the type of solvent is selected, imidization can be completed in a relatively short time, and thereby a heat treatment including pre-heating can be performed within 60 minutes. When applying the polyimide precursor, it may be applied as a polyimide precursor solution in which the polyimide precursor is dissolved in a known solvent.

In the chemical imidization, a dehydrating agent and a catalyst are added into the polyimide precursor solution to chemically perform dehydration at 30° C. to 60° C. Acetic anhydride is exemplified as a typical dehydrating agent, and pyridine is exemplified as a typical catalyst.

The chemical imidization is preferably carried out by the thermal imidization method because there is a concern of impurities being easily mixed, making steps complicated.

One kind of polyimide precursor may be imidized, or two or more kinds of polyimide precursors may be mixed and imidized at one time.

A preferred degree of polymerization of the polyimide precursor and the polyimide of the present invention is 1,000 to 100,000 cP and is preferably within a range of 3,000 to 10,000 cP as a viscosity of a polyimide precursor solution measured by an E-type viscometer. In addition, a molecular weight of the polyimide precursor can be obtained by a GPC method. As preferred ranges for a molecular weight (in terms of polystyrene) of the polyimide precursor, a range of 15,000 to 250,000 is desirable in terms of number average molecular weight (Mn), and a range of 80,000 to 800,000 is desirable in terms of weight-average molecular weight (Mw). A molecular weight of a polyimide is also within the same ranges as those for a molecular weight of its precursor. When an Mw is less than 80,000, tear propagation resistance of the polyimide is likely to decrease. When an Mw is more than 800,000, tear propagation resistance is likely to decrease, because a viscosity becomes excessively high, making it difficult to form a film, or because gel is generated, making a film uneven. When 6FDA is used but ODPA is not used, a lower limit of an Mw is more preferably 220,000 and is even more preferably 230,000. Furthermore, when ODPA is used but 6FDA is not used, a lower limit of an Mw is more preferably 180,000 and is even more preferably 200,000.

When 6FDA and ODPA are used in combination, a preferred lower limit of an Mw can be obtained from a mole fraction of 6FDA and ODPA. That is, when a total amount of 6FDA and OPDA used in the polyimide precursor and polyimide is a mol, an amount of 6FDA used is β mol, a lower limit of a preferred Mw in a case where 6FDA is used but ODPA is not used is γ, and a lower limit of a preferred Mw in a case where ODPA is used but 6FDA is not used is δ, a preferred lower limit s of an Mw is represented by the following formula.

ε=γ×β/α+δ×(α−β)/α

As described above, in the polyimide of the present invention obtained by imidizing the polyimide precursor of the present invention, a yellowness index (converted for a film thickness of 10 μm) is 10 or less and a tear propagation resistance is 1.0 mN/μm or more, and preferably, an Rth (converted for a film thickness of 10 μm) is 65 nm or less and a CTE is 100 ppm/K or less.

A yellowness index (YI) of the polyimide of the present invention may be 10 or less, is preferably 6 or less, and is more preferably 4 or less. When YI is within this range, the polyimide can be suitably used for substrates, such as TFT substrates for organic EL devices, touch panel substrates, and color filter substrates, which are required to have transparency and less coloration.

As described above, a tear propagation resistance of the polyimide of the present invention is 1.0 mN/μm or more. When it is less than 1.0 mN/μm, for example, there is a concern of breaking of a polyimide layer in a step of mounting a functional layer such as a display element on the polyimide layer and peeling off the polyimide layer from a supporting base material. A more preferred range thereof is 1.3 mN/μm or more. An even more preferred range thereof is 1.5 mN/μm or more.

Furthermore, a glass transition temperature (Tg) of the polyimide of the present invention is 250° C. or higher and is preferably 300° C. or higher from the viewpoint of heat resistance. Furthermore, a thermal decomposition temperature (10% weight loss temperature, Td1) may be 400° C. or higher.

An Rth of the polyimide of the present invention may be 65 nm or less, is preferably 45 nm or less, is more preferably 40 nm or less, and is even more preferably 30 nm or less. When an Rth is within this range, the polyimide has excellent optical characteristics such as visibility when it is used as, for example, a touch panel substrate.

When the polyimide of the present invention is in a form of a film having a thickness of 10 to 15 μm, a total light transmittance in the visible region is 70% or more and is preferably 80% or more from the viewpoint of transparency of a substrate for a flexible device. Furthermore, when the polyimide is in a form of a polyimide film having a thickness of 10 to 15 μm, a light transmittance at 450 nm is preferably 70% or more and is more preferably 80% or more.

A CTE of the polyimide of the present invention may be 100 ppm/K or less, and is preferably within a range of −10 ppm/K to 80 ppm/K. When a CTE is less than −10 ppm/K or is more than 80 ppm/K, problems such as warpage, cracks, and peeling of a display device occur due to thermal stress when mounting a display element. A CTE is more preferably within a range of 0 ppm/K to 80 ppm/K. Particularly in a case of using ODPA, an upper limit of a CTE is preferably set to 40 ppm/K, is more preferably set to 30 ppm/K, and is most preferably set to 20 ppm/K by optimizing a composition.

A method of obtaining a polyimide from the polyimide precursor of the present invention is not limited, but in a case where a polyimide is used as a resin substrate, it is advantageous to obtain a polyimide in a form of a film or as a laminate including a polyimide layer.

A polyimide laminate can be obtained by any of preferred methods: a method (1) of applying a resin solution (resin composition) containing a polyimide precursor onto a supporting base material, and thereafter performing drying and a heat treatment (imidization); a method (2) of applying a resin solution in which imidization has completed in a liquid phase onto a supporting base material, and performing drying; and a method (3) of bonding a separately produced polyimide film onto another supporting base material. From the viewpoint of production efficiency, it is desirable to form a film by performing imidization on the supporting base material, which then serves as a laminate as it is, as in the method (1), and peeling off the supporting base material as necessary. In this case, as the supporting base material, it is possible to apply known base materials such as resin base materials, glass base materials, and metal base materials, as long as it is possible to ensure heat resistance that enables the supporting base material to withstand heating when forming a polyimide layer, and peelability when peeling off the supporting base material from a polyimide laminate. From the viewpoint of a low Rth of a polyimide layer, glass and a polyimide film are preferable, and a polyimide film is more preferable.

The polyimide of the present invention is suitable as a flexible device in which a functional layer is formed on a polyimide layer containing the polyimide of the present invention. The polyimide layer in this case may be a single layer or may be composed of a plurality of layers. In the case of a single layer, a thickness is preferably set within a range of 3 μm to 100 μm. Meanwhile, in the case of a plurality of layers, it is sufficient for a main polyimide layer to serve as a polyimide film having the above-mentioned thickness. In this case, the “main polyimide layer” refers to a polyimide layer having a thickness accounting for the largest proportion among thicknesses of a plurality of polyimide layers, and is a layer made of the polyimide of the present invention, in which a thickness of the main polyimide layer is preferably within a range of 3 μm to 100 μm, and is more preferably within a range of 4 μm to 50 μm.

The polyimide of the present invention can be served as a laminate having a polyimide layer made of this polyimide, and an element layer or the like (functional layer) having various functions can be formed on a surface of the polyimide layer. Examples of functional layers include display devices including liquid crystal display devices, organic EL display devices, touch panels, and electronic paper; display devices such as color filters; and components thereof. Examples thereof further include organic EL lighting devices; touch panel devices; conductive films on which ITO and the like are laminated; touch panel films; gas barrier films for preventing permeation of moisture, oxygen, and the like; and various functional devices used in association with the above-mentioned display device and including components of flexible circuit boards. That is, the “functional layer” referred to herein includes not only components such as liquid crystal display devices, organic EL display devices, and color filters, but also includes one kind or a combination of two or more kinds of organic EL lighting devices, touch panel devices, electrode layers or light emitting layers of organic EL display devices, gas barrier films, adhesive films, thin-film transistors (TFTs), wiring layers or transparent conductive layers of liquid crystal display devices, and the like.

Regarding a method of forming the functional layer, formation conditions are appropriately set according to a target device, but in general, it is possible to use a known method in which a film such as a metal film, an inorganic film, and an organic film is formed on a polyimide film, and thereafter, patterning into a predetermined shape is performed or a heat treatment is performed as necessary. That is, a means for forming the display elements is not particularly limited, and for example, a means appropriately selected from sputtering, vapor deposition, CVD, printing, exposure, immersion, and the like may be used, and these treatments may be performed in a vacuum chamber or the like as necessary. In addition, a supporting base material and a polyimide film may be separated immediately after forming a functional layer through various process treatments, or a polyimide film may be integrated with a base material for a certain period of time, and then may be separated and removed immediately before the integrated layer is used as a display device.

Hereinafter, as an example of the flexible device of the present invention, an outline of a method for manufacturing an organic EL display device having a bottom emission structure as a functional layer will be described below.

A gas barrier layer is provided on a polyimide film containing the polyimide of the present invention (hereinafter, may be referred to as the “polyimide film of the present invention”) to form a structure capable of blocking moisture and oxygen from permeating. Next, a circuit configuration layer including a thin-film transistor (TFT) is formed on an upper surface of the gas barrier layer. In this case, LTPS-TFT having a high operating speed is mainly selected as the thin-film transistor in the organic EL display device. The circuit configuration layer is configured by forming, for example, an anode electrode made of a transparent conductive film of Indium Tin Oxide (ITO) for each of a plurality of pixel regions disposed in a matrix on an upper surface of the circuit configuration layer. Furthermore, an organic EL light emitting layer is formed on an upper surface of the anode electrode, and a cathode electrode is formed on an upper surface of the light emitting layer. This cathode electrode is formed together in each of the pixel regions. In addition, a gas barrier layer is formed again to cover a surface of the cathode electrode, and a sealing substrate is installed on an outermost surface for surface protection. From the viewpoint of reliability, it is desirable to laminate a gas barrier layer preventing moisture and oxygen from permeating also on a surface of the sealing substrate on a side of the cathode electrode. The organic EL light emitting layer is formed of a multilayer film such as a hole injection layer-hole transport layer-light emitting layer-electron transport layer (anode electrode-light emitting layer-cathode electrode), but because the organic EL light emitting layer deteriorates by moisture and oxygen, it is particularly formed by vacuum deposition and is generally formed continuously in vacuum including electrode formation.

A wavelength of light emitted from the light emitting layer of the organic EL display device is mainly 440 nm to 780 nm, and therefore a transparent resin substrate used in the organic EL display device is required to have an average transmittance of at least 80% or more in this wavelength region. Meanwhile, in a case of peeling off a polyimide layer and a supporting base material such as a glass base material by irradiating them with UV laser light, when a transmittance at a wavelength of the UV laser light is high, it is required to separately provide an absorption/peeling layer, which reduces productivity. Currently, a 308 nm laser device is generally used for this peeling. In order to perform laser lift-off, a polyimide itself is required to sufficiently absorb laser light at 308 nm, and it is desirable that light is not transmitted as much as possible. From such a viewpoint, a transmittance of the polyimide film of the present invention at 308 nm is preferably 1% or less and is more preferably 0.5% or less.

### EXAMPLES

Hereinafter, the present invention will be specifically described based on examples and comparative examples. The present invention is not limited to contents thereof.

Abbreviations of materials and evaluation methods used in the examples and the comparative examples are shown.

(Acid Dianhydride)
6FDA: 4,4′-(2,2′-hexafluoroisopropylidene)diphthalic dianhydride
ODPA: 4,4′-oxydiphthalic dianhydride
PMDA: pyromellitic anhydride

(Diamine)
TFMB: 2,2-bis(trifluoromethyl)benzidine
m-TB: 2,2′-dimethyl-4,4′-diaminobiphenyl

(Solvent)
NMP: N-methyl-2-pyrrolidone
DMAc: dimethylacetamide

(Light Transmittance T450 and Yellowness Index YI)

A light transmittance (T450) at 450 nm was obtained from a polyimide film (50 mm×50 mm) using a UV-3600 spectrophotometer of SHIMADZU.

In addition, a yellowness index (YI) was calculated based on a calculation formula represented by Formula (1).

YI=100×(1.2879×−1.0592Z)/Y (1)

[provided that, X, Y, and Z are tristimulus values of a test piece defined in JIS Z 8722]

In addition, a value YI (10) represented by Formula (2) and converted into a thickness of 10 μm was calculated.

YI(10)=(YI/thickness[μm])×10 (2)

(Coefficient of Thermal Expansion; CTE)

Using a thermomechanical analysis (TMA) device (manufactured by Hitachi High-Tech Corporation; product name TMA/AA6100), a temperature of a polyimide film (3 mm×15 mm) was raised from 30° C. to 280° C. at a constant temperature rising rate (10° C./min) while applying a load of 5.0 g, a temperature was held at 280° C. for 10 minutes and then was lowered by 30° C. from 280° C., and a CTE was measured from an amount of extension of the polyimide film at the time of lowering the temperature from 250° C. to 100° C.

(Total Light Transmittance; TT)

A total light transmittance of a polyimide film (50 mm×50 mm) was measured using a haze meter (manufactured by NIPPON DENSHOKU INDUSTRIES CO., LTD.; product name HAZE METER NDH500).

(Glass Transition Temperature; Tg)

Using a dynamic viscoelasticity measurement (manufactured by TA Instruments Japan Inc.; product name RAS-G2), a dynamic viscoelasticity when a temperature of a polyimide film (5 mm×70 mm) was raised from 23° C. to 450° C. at 5° C./min was measured, and a temperature at which a maximum value of tan δ was shown was defined as a glass transition temperature (Tg).

(Retardation in Thickness Direction; Rth)

First, a birefringence and phase difference evaluation device (WPA-100 manufactured by Photonic Lattice, Inc.), which was equipped with a rotating device that causes a sample to rotate for changing an incident angle of light incident on the sample, was prepared. Using this device, an incident angle dependence of a retardation at a wavelength of 543 nm of a polyimide film (50 mm×50 mm) was measured.

Data of the measurement was numerically analyzed to obtain a retardation Rth in a thickness direction. A value converted for a film thickness of 10 μm was defined as Rth10.

(Tear Propagation Resistance)

A test piece of a polyimide film (63.5 mm×50 mm) was prepared, a cut with a length of 12.7 mm was made in the test piece, and a tear propagation resistance value at room temperature was measured using a light load type tearing tester (manufactured by Toyo Seiki Seisaku-sho, Ltd.). The measured tear propagation resistance value was expressed as a resistance value (kN/m) per unit thickness.

(Molecular Weight; Mw)

A molecular weight was measured by gel permeation chromatography (trade name; HLC-8220GPC, manufactured by TOSOH CORPORATION). Polystyrene was used as a standard substance, and N,N-dimethylacetamide was used as a developing solvent.

(Tensile Strength and Tensile Elongation)

A test piece of a polyimide film (10 mm×15 mm) was prepared, and a tensile test was conducted at a tensile speed of 10 mm/min using a TENSILON universal testing machine (RTA-250 manufactured by ORIENTEC CO., LTD.). An average value of five samples was calculated and used for tensile elongation and tensile strength.

Polyimide precursor solutions A to C and H to T were prepared according to the following synthesis examples.

### Synthesis Example 1

Under a nitrogen stream, 156.45 g of TFMB was dissolved in 2,125 g of DMAc in a 3,000-ml separable flask. Next, 218.99 g of 6FDA was added. A molar ratio (a/b) of an acid dianhydride (a) and a diamine (b) was set to 1.009. This solution was heated at 45° C. for 2 hours to dissolve the contents. Thereafter, the solution was stirred at room temperature for 10 hours to perform a polymerization reaction. Thereby, a polyimide (PI) precursor solution A (viscous solution) having a high degree of polymerization was obtained. Table 1 shows a composition, a concentration of solid contents, an Mw of the polyimide (PI) precursor solution A, and the like.

### Synthesis Example 2

Under a nitrogen stream, 6.28 g of TFMB and 8.72 g of 6FDA were dissolved in 85 g of DMAc in a 300-ml separable flask. A molar ratio (a/b) of an acid dianhydride (a) and a diamine (b) was set to 1.0. A temperature of this solution was raised from room temperature to 80° C. while stirring, and the solution was stirred at 80° C. for 6 hours to perform a polymerization reaction. Thereby, a polyimide (PI) precursor solution B (viscous solution) having a high degree of polymerization was obtained. Table 1 shows a composition, a concentration of solid contents, an Mw of the polyimide (PI) precursor solution B, and the like.

### Synthesis Example 3

Under a nitrogen stream, 6.28 g of TFMB was dissolved in 85 g of DMAc in a 300-ml separable flask. Next, 8.72 g of 6FDA was added. A molar ratio (a/b) of an acid dianhydride (a) and a diamine (b) was set to 1.0. This solution was stirred at room temperature (20° C.) for 3 hours without heating it to perform a polymerization reaction. Thereby, a polyimide (PI) precursor solution C (viscous solution) having a high degree of polymerization was obtained. Table 1 shows a composition, a concentration of solid contents, an Mw of the polyimide (PI) precursor solution C, and the like.

### Synthesis Example 4

Under a nitrogen stream, a diamine was dissolved in NMP in a 3,000-ml separable flask according to a composition shown in Table 1, and then an acid dianhydride was added. This solution was heated at 45° C. for 2 hours to dissolve the contents. Thereafter, the solution was stirred at room temperature for 10 hours to perform a polymerization reaction. Thereby, a polyimide (PI) precursor solution H (viscous solution) having a high degree of polymerization was obtained. Table 1 shows a composition, a concentration of solid contents, an Mw of the polyimide (PI) precursor solution H, and the like.

### Synthesis Example 5

Under a nitrogen stream, a diamine was dissolved in NMP in a 3,000-ml separable flask according to a composition shown in Table 1, and then an acid dianhydride was added. This solution was heated at 45° C. for 2 hours to dissolve the contents. Thereafter, the solution was stirred at room temperature for 10 hours to perform a polymerization reaction. Thereby, a polyimide (PI) precursor solution I (viscous solution) having a high degree of polymerization was obtained. Table 1 shows a composition, a concentration of solid contents, an Mw of the polyimide (PI) precursor solution I, and the like.

### Synthesis Example 6

Under a nitrogen stream, a diamine was dissolved in NMP in a 3,000-ml separable flask according to a composition shown in Table 1, and then an acid dianhydride was added. This solution was heated at 45° C. for 2 hours to dissolve the contents. Thereafter, the solution was stirred at room temperature for 30 hours to perform a polymerization reaction. Thereby, a polyimide (PI) precursor solution J (viscous solution) having a high degree of polymerization was obtained. Table 1 shows a composition, a concentration of solid contents, an Mw of the polyimide (PI) precursor solution J, and the like.

### Synthesis Example 7

Under a nitrogen stream, a diamine was dissolved in NMP in a 3,000-ml separable flask according to a composition shown in Table 2, and then an acid dianhydride was added. This solution was heated at 45° C. for 2 hours to dissolve the contents. Thereafter, the solution was stirred at room temperature for 30 hours to perform a polymerization reaction. Thereby, a polyimide (PI) precursor solution K (viscous solution) having a high degree of polymerization was obtained. Table 2 shows a composition, a concentration of solid contents, an Mw of the polyimide (PI) precursor solution K, and the like.

### Synthesis Example 8

Under a nitrogen stream, a diamine was dissolved in NMP in a 3,000-ml separable flask according to a composition shown in Table 2, and then an acid dianhydride was added. This solution was heated at 45° C. for 2 hours to dissolve the contents. Thereafter, the solution was stirred at room temperature for 30 hours to perform a polymerization reaction. Thereby, a polyimide (PI) precursor solution L (viscous solution) having a high degree of polymerization was obtained. Table 2 shows a composition, a concentration of solid contents, an Mw of the polyimide (PI) precursor solution L, and the like.

### Synthesis Example 9

Under a nitrogen stream, a diamine was dissolved in NMP in a 3,000-ml separable flask according to a composition shown in Table 2, and then an acid dianhydride was added. This solution was heated at room temperature (23° C.) for 3 hours to dissolve the contents. Thereafter, the solution was stirred at room temperature for 3 hours to perform a polymerization reaction. Thereby, a polyimide (PI) precursor solution M (viscous solution) having a high degree of polymerization was obtained. Table 2 shows a composition, a concentration of solid contents, an Mw of the polyimide (PI) precursor solution M, and the like.

### Synthesis Example 10

Under a nitrogen stream, a diamine was dissolved in NMP in a 3,000-ml separable flask according to a composition shown in Table 2, and then an acid dianhydride was added. This solution was heated at 45° C. for 2 hours to dissolve the contents. Thereafter, the solution was stirred at room temperature for 30 hours to perform a polymerization reaction. Thereby, a polyimide (PI) precursor solution N (viscous solution) having a high degree of polymerization was obtained. Table 2 shows a composition, a concentration of solid contents, an Mw of the polyimide (PI) precursor solution N, and the like.

### Synthesis Example 11

Under a nitrogen stream, a diamine was dissolved in NMP in a 3,000-ml separable flask according to a composition shown in Table 2, and then an acid dianhydride was added. A temperature of this solution was raised from room temperature to 80° C. while stirring, and the solution was stirred at 80° C. for 6 hours to perform a polymerization reaction. Thereby, a polyimide (PI) precursor solution O (viscous solution) having a high degree of polymerization was obtained. Table 2 shows a composition, a concentration of solid contents, an Mw of the polyimide (PI) precursor solution O, and the like.

### Synthesis Example 12

Under a nitrogen stream, a diamine was dissolved in NMP in a 3,000-ml separable flask according to a composition shown in Table 2, and then an acid dianhydride was added. This solution was stirred at room temperature (20° C.) for 3 hours without heating it to perform a polymerization reaction. Thereby, a polyimide (PI) precursor solution P (viscous solution) having a high degree of polymerization was obtained. Table 2 shows a composition, a concentration of solid contents, an Mw of the polyimide (PI) precursor solution P, and the like.

### Synthesis Example 13

Under a nitrogen stream, a diamine was dissolved in NMP in a 3,000-ml separable flask according to a composition shown in Table 2, and then an acid dianhydride was added. This solution was heated at 45° C. for 2 hours to dissolve the contents. Thereafter, the solution was stirred at room temperature for 30 hours to perform a polymerization reaction. Thereby, a polyimide (PI) precursor solution T (viscous solution) having a high degree of polymerization was obtained. Table 2 shows a composition, a concentration of solid contents, an Mw of the polyimide (PI) precursor solution T, and the like.

TABLE 1

| | Synthesis | Synthesis | Synthesis | Synthesis | Synthesis | Synthesis |
|---|---|---|---|---|---|---|
| | Example 1 | Example 2 | Example 3 | Example 4 | Example 5 | Example 6 |
| TFMB (g) | 156.45 | 6.28 | 6.28 | 199.19 | 212.47 | 190.34 |
| 6FDA (g) | 218.99 | 8.72 | 8.72 | 81.98 | 36.66 | |
| ODPA (g) | | | | | | 184.66 |
| PMDA (g) | | | | 93.83 | 125.87 | |
| DMAc (g) | 2125 | 85 | 85 | | | |
| NMP (g) | | | | 2125 | 2125 | 2125 |
| Total (g) | 2500 | 100 | 100 | 2500 | 2500 | 2500 |
| Concentration of | 15 | 15 | 15 | 15 | 15 | 15 |
| solid contents (wt %) | | | | | | |
| a/b | 1.009 | 1.0 | 1.0 | 0.989 | 0.995 | 1.0015 |
| Mw of PI precursor | 250000 | 850000 | 70000 | 340000 | 540000 | 366000 |
| PI precursor solution | A | B | C | H | I | J |

TABLE 2

| | Synthesis | Synthesis | Synthesis | Synthesis | Synthesis | Synthesis | Synthesis |
|---|---|---|---|---|---|---|---|
| | Example 7 | Example 8 | Example 9 | Example 10 | Example 11 | Example 12 | Example 13 |
| TFMB (g) | 213.25 | 209.85 | 224.52 | 206.55 | 190.34 | 190.34 | 253.79 |
| 6FDA (g) | | | | | | | |
| ODPA (g) | 61.29 | 80.42 | | 98.94 | 184.66 | 184.66 | 246.21 |
| PMDA (g) | 100.46 | 84.73 | 150.48 | 69.5 | | | |
| NMP (g) | 2125 | 2125 | 2125 | 2125 | 2125 | 2125 | 2000 |
| Total (g) | 2500 | 2500 | 2500 | 2500 | 2500 | 2500 | 2500 |
| Concentration of | 15 | 15 | 15 | 15 | 15 | 15 | 20 |
| solid contents | | | | | | | |
| (wt %) | | | | | | | |
| a/b | 0.989 | 0.989 | 0.985 | 0.989 | 1.0015 | 1.0015 | 1.002 |
| Mw of PI | 25000 | 31000 | 189000 | 350000 | 70000 | 30000 | 530000 |
| precursor | | | | | | | |
| PI precursor | K | L | M | N | O | P | T |
| solution | | | | | | | |

### Synthesis Example 14

Under a nitrogen stream, 50 g of the polyimide (PI) precursor solution M obtained in Synthesis Example 9 was added into a 300-ml separable flask. Next, 50 g of the polyimide (PI) precursor solution N obtained in Synthesis Example 10 was added. The solution was stirred at room temperature for 3 hours, and thereby a highly viscous polyimide (PI) precursor solution Q was obtained.

### Synthesis Example 15

Under a nitrogen stream, 50 g of the polyimide (PI) precursor solution L obtained in Synthesis Example 8 was added into a 300-ml separable flask. Next, 50 g of the polyimide (PI) precursor solution I obtained in Synthesis Example 5 was added. The solution was stirred at room temperature for 3 hours, and thereby a highly viscous polyimide (PI) precursor solution S was obtained.

### Synthesis Example 16

Under a nitrogen stream, 50 g of the polyimide (PI) precursor solution N obtained in Synthesis Example 10 was added into a 300-ml separable flask. Next, 50 g of the polyimide (PI) precursor solution I obtained in Synthesis Example 5 was added. The solution was stirred at room temperature for 3 hours, and thereby a highly viscous polyimide (PI) precursor solution R was obtained.

### Example 1

A solvent DMAc was added into the polyimide precursor solution A obtained in Synthesis Example 1 to dilute the solution to a viscosity of 4,000 cP. Using a bar coater, the mixed solution was then applied on a 75-μm polyimide film (UBE INDUSTRIES, LTD., UPILEX-S) as a supporting base material so that a thickness of a polyimide layer after imidization was about 10 μm. Subsequently, heating was performed at 100° C. for 15 minutes. Next, the temperature was raised from 100° C. to 400° C. in a nitrogen atmosphere in 10 minutes to form a polyimide layer (polyimide A) on the supporting base material. Thereafter, the supporting base material was peeled off to obtain a polyimide (PI) film A. The above-mentioned peeling was performed by making a cut around only the formed polyimide layer using a cutter to determine a range to be peeled, and then peeling from the supporting base material using tweezers. Table 3 shows a thickness, CTE, Tg, TT, T450, Rth10, YI (10), tear propagation resistance, elongation, and strength of the polyimide (PI) film A.

### Example 2

A solvent DMAc was added into the polyimide precursor solution A obtained in Synthesis Example 1 to dilute the solution to a viscosity of 4,000 cP. Using a bar coater, the mixed solution was then applied on a 75-μm polyimide film (UBE INDUSTRIES, LTD., UPILEX-S) as a supporting base material so that a thickness of a polyimide layer after imidization was about 10 μm. Subsequently, drying was performed by heating at 120° C. for 10 minutes to remove the solvent. Next, the supporting base material was introduced into a heating furnace by holding the end portion of the film in a width direction of the supporting base material using a gripping tool, and was stretched by 10% in the width direction of the supporting base material while being subjected to a heat treatment from 180° C. to 360° C. at a temperature rising rate of about 30° C./min. Thereby, a polyimide layer (polyimide B) was formed on the supporting base material. Thereafter, the supporting base material was peeled off to obtain a polyimide (PI) film B. The above-mentioned peeling was performed by making a cut around only the formed polyimide layer using a cutter to determine a range to be peeled, and then peeling from the supporting base material using tweezers. Table 3 shows a thickness, CTE, Tg, TT, T450, Rth10, YI (10), tear propagation resistance, elongation, and strength of the polyimide (PI) film B.

### Example 3

A solvent DMAc was added into the polyimide precursor solution A obtained in Synthesis Example 1 to dilute the solution to a viscosity of 4,000 cP. Using a bar coater, the mixed solution was then applied on a 75-μm polyimide film (UBE INDUSTRIES, LTD., UPILEX-S) as a supporting base material so that a thickness of a polyimide layer after imidization was about 10 μm. Subsequently, drying was performed by heating at 120° C. for 10 minutes to remove the solvent. Next, the supporting base material was introduced into a heating furnace by holding the end portion of the film in a width direction of the supporting base material using a gripping tool, and was stretched by 20% in the width direction of the supporting base material while being subjected to a heat treatment from 180° C. to 360° C. at a temperature rising rate of about 30° C./min. Thereby, a polyimide layer (polyimide C) was formed on the supporting base material. Thereafter, the supporting base material was peeled off to obtain a polyimide (PI) film C. The above-mentioned peeling was performed by making a cut around only the formed polyimide layer using a cutter to determine a range to be peeled, and then peeling from the supporting base material using tweezers. Table 3 shows a thickness, CTE, Tg, TT, T450, Rth10, YI (10), tear propagation resistance, elongation, and strength of the polyimide (PI) film C.

### Example 4

A solvent DMAc was added into the polyimide precursor solution A obtained in Synthesis Example 1 to dilute the solution to a viscosity of 4,000 cP. Using a bar coater, the mixed solution was then applied on a 75-μm polyimide film (UBE INDUSTRIES, LTD., UPILEX-S) as a supporting base material so that a thickness of a polyimide layer after imidization was about 10 μm. Subsequently, drying was performed by heating at 120° C. for 10 minutes to remove the solvent. Next, the temperature was raised from room temperature to 360° C. at a constant temperature rising rate (4° C./min) in a nitrogen atmosphere, and the temperature was further maintained at 360° C. for 10 minutes. Thereafter, the temperature was returned to room temperature in 3 hours in a nitrogen atmosphere to form a polyimide layer (polyimide D) on the supporting base material. Thereafter, the supporting base material was peeled off to obtain a polyimide (PI) film D. The above-mentioned peeling was performed by making a cut around only the formed polyimide layer using a cutter to determine a range to be peeled, and then peeling from the supporting base material using tweezers. Table 3 shows a thickness, CTE, Tg, TT, T450, Rth10, YI (10), tear propagation resistance, elongation, and strength of the polyimide (PI) film D.

### Example 5

A solvent DMAc was added into the polyimide precursor solution A obtained in Synthesis Example 1 to dilute the solution to a viscosity of 4,000 cP. Using a bar coater, the mixed solution was then applied on a 100-μm glass substrate as a supporting base material so that a thickness of a polyimide layer after imidization was about 10 μm. Subsequently, drying was performed by heating at 120° C. for 10 minutes to remove the solvent. Next, the temperature was raised from room temperature to 370° C. at a constant temperature rising rate (4° C./min) in a nitrogen atmosphere, and the temperature was further maintained at 370° C. for 30 minutes. Thereafter, the temperature was returned to room temperature in 4 hours in a nitrogen atmosphere to form a polyimide layer (polyimide E) on the supporting base material. Thereafter, the supporting base material was peeled off to obtain a polyimide (PI) film E. The above-mentioned peeling was performed by making a cut around only the formed polyimide layer using a cutter to determine a range to be peeled, and then peeling from the supporting base material using tweezers. Table 3 shows a thickness, CTE, Tg, TT, T450, Rth10, YI (10), tear propagation resistance, elongation, and strength of the polyimide (PI) film E.

### Comparative Example 1

A solvent DMAc was added into the polyimide precursor solution B obtained in Synthesis Example 2 to dilute the solution to a viscosity of 4,000 cP. Using a bar coater, the mixed solution was then applied on a 100-μm glass substrate as a supporting base material so that a thickness of a polyimide layer after imidization was about 10 μm. Subsequently, drying was performed by heating at 120° C. for 10 minutes to remove the solvent. Thereafter, heating was performed at 350° C. for 30 minutes to form a polyimide layer (polyimide F) on the supporting base material. Thereafter, the supporting base material was peeled off to obtain a polyimide (PI) film F. The above-mentioned peeling was performed by making a cut around only the formed polyimide layer using a cutter to determine a range to be peeled, and then peeling from the supporting base material using tweezers. Table 3 shows a thickness, CTE, Tg, TT, T450, Rth10, YI (10), tear propagation resistance, elongation, and strength of the polyimide (PI) film F.

### Comparative Example 2

A solvent DMAc was added into the polyimide precursor solution C obtained in Synthesis Example 3 to dilute the solution to a viscosity of 4,000 cP. Using a bar coater, the mixed solution was then applied on a 100-μm glass substrate as a supporting base material so that a thickness of a polyimide layer after imidization was about 10 μm. Subsequently, drying was performed by heating at 120° C. for 10 minutes to remove the solvent. Next, the temperature was raised from room temperature to 360° C. at a constant temperature rising rate (4° C./min) in a nitrogen atmosphere, and the temperature was further maintained at 360° C. for 10 minutes. Thereafter, the temperature was returned to room temperature in 3 hours in a nitrogen atmosphere to form a polyimide layer (polyimide G) on the supporting base material. Thereafter, the supporting base material was peeled off to obtain a polyimide (PI) film G. The above-mentioned peeling was performed by making a cut around only the formed polyimide layer using a cutter to determine a range to be peeled, and then peeling from the supporting base material using tweezers. Table 3 shows a thickness, CTE, Tg, TT, T450, Rth10, YI (10), tear propagation resistance, elongation, and strength of the polyimide (PI) film G.

Various evaluations were performed on the obtained polyimide (PI) films A to G. The results are shown in Table 3.

### Examples 6 to 14 and Comparative Examples 3 to 5

A polyimide layer having a thickness of 10 μm was formed on a 100-μm glass substrate as a supporting base material under the same conditions as in Example 5 except that polyimide precursor solutions shown in Tables 4 and 5 were respectively used instead of the polyimide precursor solution A. Next, a polyimide (PI) film was obtained. The types of the obtained polyimide layers and polyimide (PI) films are also shown in Tables 4 and 5.

Tables 4 and 5 show a thickness, CTE, Tg, TT, T450, Rth10, YI (10), tear propagation resistance, elongation, and strength of the obtained polyimide (PI) films.

### Examples 15 to 23

A polyimide layer was formed under the same conditions as in Example 5 except that polyimide precursor solutions shown in Table 6 were respectively used and applied on a 100-μm glass substrate as a supporting base material so that a thickness of a polyimide layer obtained by imidization was a thickness shown in Table 6. Next, a polyimide (PI) film was obtained. The types of the obtained polyimide layers and polyimide (PI) films are also shown in Table 6. Table 6 shows a thickness, CTE, Tg, TT, T450, Rth10, YI (10), tear propagation resistance, elongation, and strength of the obtained polyimide (PI) films.

TABLE 3

| | | | | | | Comparative | Comparative |
|---|---|---|---|---|---|---|---|
| | Example 1 | Example 2 | Example 3 | Example 4 | Example 5 | Example 1 | Example 2 |
| PI film | A | B | C | D | E | F | G |
| PI thickness | 10 | 10 | 10 | 10 | 10 | 10 | 10 |
| (μm) | | | | | | | |
| CTE (ppm/K) | 69 | 67 | 66 | 69 | 70 | 53 | — |
| Tg (° C.) | 335 | 335 | 335 | 335 | 335 | — | — |
| TT (%) | 92 | 92 | 92 | 91 | 91 | — | — |
| T450 (%) | 90 | 90 | 90 | 90 | 90 | — | — |
| Rth10 (nm) | 15 | 16 | 19 | 34 | 61 | 92 | — |
| YI (10) | 1.4 | 1.7 | 1.3 | 1.8 | 1.8 | 1.8 | 1.8 |
| Tear | 1.7 | 1.7 | 1.6 | 1.7 | 1.6 | 0.9 | 0.8 |
| propagation | | | | | | | |
| resistance | | | | | | | |
| (kN/m) | | | | | | | |
| Elongation (%) | 7.4 | 7.4 | 7.4 | 7.4 | 7.4 | 5.6 | 3.4 |
| Strength (MPa) | 135 | 135 | 135 | 135 | 135 | 130 | 94 |
| PI precursor | A | A | A | A | A | B | C |
| solution | | | | | | | |

TABLE 4

| | | Example | Example | Example | Example | Example | Comparative | Comparative | Comparative |
|---|---|---|---|---|---|---|---|---|---|
| | Example 6 | 7 | 8 | 9 | 10 | 11 | Example 3 | Example 4 | Example 5 |
| PI film | H | J | K | L | N | T | O | P | I |
| PI thickness | 10 | 10 | 10 | 10 | 10 | 10 | 10 | 10 | 10 |
| (μm) | | | | | | | | | |
| CTE | 25 | 71 | 12.3 | 23.8 | 37.9 | 71 | 71 | 71 | 3.6 |
| (ppm/K) | | | | | | | | | |
| Tg (° C.) | >400 | 335 | 403 | 401 | | 335 | 325 | 320 | >400 |
| TT (%) | 89 | 89 | 87 | 87 | | 87 | 89 | 89 | 88 |
| T450 (%) | 84 | 84 | 82 | 86 | 82.3 | 84 | 84 | 84 | 82 |
| Rth10 (nm) | | 96 | | 68.5 | | 96 | 101 | 105 | |
| YI (10) | 7.1 | 2.7 | 7.8 | 5.8 | 7.5 | 2.7 | 3.2 | 3.3 | 11.2 |
| Tear | 1.5 | 1.3 | 1.6 | 1.7 | 1.9 | 1.4 | 0.5 | 0.3 | 1.4 |
| propagation | | | | | | | | | |
| resistance | | | | | | | | | |
| (kN/m) | | | | | | | | | |
| Elongation | 40 | 45 | 30 | 35 | 40 | 48 | 9 | 5 | 37 |
| (%) | | | | | | | | | |
| Strength | 210 | 167 | 289 | 290 | 301 | 170 | 110 | 90 | 294 |
| (MPa) | | | | | | | | | |
| PI | H | J | K | L | N | T | O | P | I |
| precursor | | | | | | | | | |
| solution | | | | | | | | | |

TABLE 5

| | Example 12 | Example 13 | Example 14 |
|---|---|---|---|
| PI film | Q | R | S |
| PI thickness (μm) | 10 | 10 | 10 |
| CTE (ppm/K) | 7.8 | 10 | 11 |
| Tg (° C.) | 389 | 17 | 405 |
| TT (%) | 87 | 403 | 87 |
| T450 (%) | 82 | 85 | 82 |
| YI (10) | 8.5 | 6.7 | 7.9 |
| Tear propagation | 1.8 | 2 | 1.9 |
| resistance (kN/m) | | | |
| Elongation (%) | 34.4 | 36.8 | 26 |
| Strength (MPa) | 303 | 289 | 250 |
| PI precursor solution | Q | R | S |

TABLE 6

| | Example | Example | Example | Example | Example | Example | Example | Example | Example |
|---|---|---|---|---|---|---|---|---|---|
| | 15 | 16 | 17 | 18 | 19 | 20 | 21 | 22 | 23 |
| PI film | K-8 | K-6 | Q-8 | Q-6 | S-8 | S-6 | E-9 | E-11 | E-15 |
| PI | 8 | 6 | 8 | 6 | 8 | 6 | 9 | 11 | 15 |
| thickness | | | | | | | | | |
| (μm) | | | | | | | | | |
| CTE | 12.3 | 11.7 | 392 | 7.8 | 11 | 11 | 71 | 71 | 71 |
| (ppm/K) | | | | | | | | | |
| Tg (° C.) | 403 | 403 | 87 | 390 | 401 | 405 | 335 | 335 | 335 |
| TT (%) | 87 | 87 | 85 | 87 | 87 | 88 | 92 | 92 | 91 |
| T450 (%) | 80 | 82 | 85 | 88 | 83 | 83 | 90 | 90 | 89 |
| Rth10 (nm) | | | | | | | 61 | 67 | 92 |
| YI (10) | 8.6 | 10.0 | 9.2 | 10.0 | 9.1 | 9.7 | 1.8 | 2.0 | 2.7 |
| Tear | 1.2 | 1.0 | 1.3 | 1.1 | 1.2 | 1.0 | 1.4 | 1.8 | 2.6 |
| propagation | | | | | | | | | |
| resistance | | | | | | | | | |
| (kN/m) | | | | | | | | | |
| Elongation | 41 | 23 | 19 | 35 | 29 | 10 | 7.4 | 7.6 | 13 |
| (%) | | | | | | | | | |
| Strength | 384 | 220 | 236 | 328 | 272 | 181 | 135 | 130 | 129 |
| (MPa) | | | | | | | | | |
| PI | K | K | Q | Q | S | S | A | A | A |
| precursor | | | | | | | | | |
| solution | | | | | | | | | |

### Comparative Example 6

Under a nitrogen stream, 18.55 g of m-TB was dissolved in 212.5 g of DMAc in a 300-ml separable flask. Next, 18.95 g of PMDA was added. A molar ratio (a/b) of an acid dianhydride (a) and a diamine (b) was set to 0.995. This solution was caused to react by stirring it at room temperature for 3 hours, and thereby a polyimide (PI) precursor solution (viscous solution) having a high degree of polymerization was obtained. A film was formed in the same manner as in Example 2, and optical characteristics were measured. A YI was 51, showing that the film was a yellow film.

### Comparative Example 7

Under a nitrogen stream, 18.55 g of m-TB was dissolved in 212.5 g of DMAc in a 300-ml separable flask. Next, 18.95 g of PMDA was added. A molar ratio (a/b) of an acid dianhydride (a) and a diamine (b) was set to 0.995. This solution was heated at 45° C. for 2 hours to dissolve the contents. Thereafter, when the solution was stirred for 10 minutes to perform a polymerization reaction, viscosity of the resin increased significantly, showing that the entire solution was gelatinized as a whole. The film could not be formed.

Although the embodiments of the present invention have been described in detail for the purpose of exemplification, the present invention is not limited to the above-described embodiments.

The present application claims priority based on Japanese Patent Application No. 2018-186221 (filing date: Sep. 29, 2018), and the entire contents of the application are incorporated herein by reference.

1. A polyimide precursor comprising:
a structural unit derived from a diamine; and
a structural unit derived from a tetracarboxylic dianhydride,
wherein, i) as the structural unit derived from a diamine, a structural unit derived from 2,2′-bis(trifluoromethyl)benzidine is contained in an amount of 60% by mole or more with respect to all structural units derived from a diamine, and
ii) as the structural unit derived from a tetracarboxylic dianhydride, structural units containing a structural unit derived from 4,4′-oxydiphthalic dianhydride as an essential component, and derived from one or more kinds selected from 4,4′-(2,2′-hexafluoroisopropylidene)diphthalic dianhydride and 4,4′-oxydiphthalic dianhydride are contained in a total amount of 20% by mole or more with respect to all structural units derived from a tetracarboxylic dianhydride,
wherein a weight-average molecular weight is within a range of 180,000 to 800,000, and
wherein a yellowness index (converted for a film thickness of 10 μm) for a polyimide obtained by imidization is 10 or less, and a tear propagation resistance is 1.0 mN/μm or more.

2. (canceled)

3. The polyimide precursor according to claim 1, wherein an elongation of a polyimide film obtained by imidization at a film thickness of 5 to 20 μm is 10% or more.

4. The polyimide precursor according to claim 1, wherein a retardation (converted for a film thickness of 10 μm) in a thickness direction of a polyimide film obtained by imidization is 65 nm or less.

5. A polyimide comprising:
a structural unit derived from a diamine; and
a structural unit derived from a tetracarboxylic dianhydride,
wherein, i) as the structural unit derived from a diamine, a structural unit derived from 2,2′-bis(trifluoromethyl)benzidine is contained in an amount of 60% by mole or more with respect to all structural units derived from a diamine, and
ii) as the structural unit derived from a tetracarboxylic dianhydride, structural units containing a structural unit derived from 4,4′-oxydiphthalic dianhydride as an essential component, and derived from one or more kinds selected from 4,4′-(2,2′-hexafluoroisopropylidene)diphthalic dianhydride and 4,4′-oxydiphthalic dianhydride are contained in a total amount of 20% by mole or more with respect to all structural units derived from a tetracarboxylic dianhydride,
wherein a weight-average molecular weight is within a range of 180,000 to 800,000, and
wherein a yellowness index (converted for a film thickness of 10 μm) is 10 or less, and a tear propagation resistance is 1.0 mN/μm or more.

6. The polyimide according to claim 5, wherein an elongation in a state of a film having 5 to 20 μm is 10% or more.

7. The polyimide according to claim 5, wherein a retardation (converted for a film thickness of 10 μm) in a thickness direction in a state of a film is 65 nm or less.

8. The polyimide according to claim 5, wherein, as the structural unit derived from a diamine, the structural unit derived from 2,2′-bis(trifluoromethyl)benzidine is contained in an amount of 80% by mole or more with respect to the all structural units derived from a diamine.

9. The polyimide according to claim 5, wherein, as the structural unit derived from a tetracarboxylic dianhydride, the structural units derived from one or more kinds selected from 4,4′-(2,2′-hexafluoroisopropylidene)diphthalic dianhydride and 4,4′-oxydiphthalic dianhydride are contained in a total amount of 25% by mole or more with respect to the all structural units derived from a tetracarboxylic dianhydride.

10. A flexible device comprising:
a polyimide layer; and
a functional layer formed on the polyimide layer,
wherein the polyimide layer contains the polyimide according to claim 5.
